(19) United States
(12) Patent Application Publication
(10) Pub. No.: US 2022/0361681 A1
(43) Pub. Date: Nov. 17, 2022

(54) Kind of Easy Assembly Metal Bed Frame

(71) Applicant: Guangdong Zongheng Home Furnishing Co., Ltd., Guangzhou (CN)

(72) Inventor: Shidong Jiang, Guangzhou (CN)

(21) Appl. No.: 17/318,049

(22) Filed: May 12, 2021

(51) Int. Cl. A47C 19/02; F16B 12/30; F16B 12/56

(52) U.S. Cl. CPC A47C 19/027; F16B 12/30; F16B 12/56; A47C 19/12

(57) ABSTRACT

This invention is involved in the manufacturing technology, which is a kind of easy assembly metal bed frame. This metal bed frame includes metal frames, the first main slats, supports and supporting rods. The ends of the bed frame are welded with metal plate connections which have elliptic holes at both ends. The bed frame consists of two main bars at both sides, setting fixed slot at the inner side. At both ends, the first main slats are the mobile connection and the second main salts, which can be vertically connected with support by using bolts to link through the fixed holes at the upper and down sides of the second main slats, are the fixed connection. In the middle of the bed frame, the bars are insetted elliptic nuts on one side and bolts on the other side and links the supporting rods at the bottom. Using plastic fasteners to connect the bed frame and slats is easy to operate and durable. Supports not only insure the stability and safety of the metal bed frame, but also create an opportunity to use light slats in order to reduce the weight of bed frame.

### FIELD OF THE INVENTION

This invention is involved in the manufacturing technology, which is a kind of easy assembly metal bed frame.

### BACKGROUND OF THE INVENTION

The original meaning of the bed is the common furniture for sleeping. Because the wooden bed is not stable enough and it will cause decay due to humidity or long time, which is easy to cause safety hazards. Therefore, iron beds have appeared, and they are generally divided into single layers iron beds, double-layer iron beds and triple-layer iron beds. Basically, it is made of ordinary iron pipe or angle steel through welding. The iron bed production process is generally from blanking, drilling, welding, sanding, pickling, phosphating to spraying. The places of using beds are mostly student dormitories, staff dormitories, makeshift houses in construction sites, apartments, etc.

With the development of science and technology, people's pursuit of material life is also increasing. There are a variety of bed styles on the market. Because a large number of people buy iron beds on the e-commerce platform to assemble it by them, one is portable and easy to install. A solid iron bed is a necessity for people working and studying in different places. However, the iron bed designed and manufactured by traditional technology has the following three shortcomings. First, it is bulky, heavy and not easy to handle. Second, there are many installation screws, and sometimes different installation tools are needed. Third, the structure is unstable because the bed bar and the bed frame are deformed and the screws are loose after using for a period of time. Therefore, those skilled in the art provide a metal bed frame which is easy to assemble and solve the problems mentioned in the background of the invention.

### DESCRIPTION OF THE INVENTION

The goal of the present invention is to provide a metal bed frame that is easy to install, so as to solve the problems mentioned in the

### BACKGROUND OF THE INVENTION

To achieve the goal mentioned above, the present invention provides the following technical method. A metal bed frame which is easy assembly, comprising a bed frame, the first main slats, supports and supporting rods, characterized in that: two ends of the bed frame are welded metal plate connections, and the structure of the bed frame is a hollow tubular structure. Metal plate connections are provided with elliptical holes, and said the elliptical holes are symmetrically distributed at the both ends of the metal plate connections. The bed frame is provided with two bars which are set fixed slot at the inner side of the bed frame. One side of the bed frame is movably connected with the first main slats and is fixedly connected with the second main slat. And the top surfaces of the second main slats are provided with fixed slots. Said the first main slats and the second main slats, which are provided with a number of them, are the hollow tubular structure. Said the bottom sides of the second main slats are connected to the supports by screws. For the single bed frame, two supports are provided symmetrically. And for the double bed frame, there are four supports which link to the second main slats vertically by using screws. In the middle of the bed frame, the bars are insetted elliptic pillar nuts on one side and bolts on the other side, and both elliptic nuts which provide inner hexagonal slots in order to assemble easily and bolt are threaded connection. The bed frame is linked to supporting rods at the bottom.

As a preferred technical method of the present invention, said supporting rods are set U shaped metal plate connections at the top surfaces, and said U shaped metal plate connections are provided several elliptic holes at the both ends.

As a preferred technical method of the present invention, said bed frame is connected by mortise and tenon techniques. One side of the bed frame fixes with the mortise block which insets the other side of the bed frame and is provided with elliptic slots. There are elliptic through holes 10 which share the same side with the elliptic holes on the side face of the bed frame.

As a preferred technical method of the present invention, said elliptic pillar nuts have the threaded holes on the other side and the bolts is connected to threaded rods which inlay the spring lock washers that have the metal washers on one side's sliding joint. Said threaded rods and the threaded holes make a threaded connection.

As a preferred technical method of the present invention, said the first main slats and the second main slats are insetted plastic fasteners which are connected to fixed slots by the mortise and tenon techniques, and the outside size of plastic fasteners and the fixed slots share the same size.

As a preferred technical method of the present invention, said each supports are equipped with rivet nuts and are fixed with the second main slats by using bolts holding the first main slats.

Compared with existing technologies, the present invention has following advantages. This kind of easy assembly metal bed frame which has a reasonable structure and is easy to assemble provides users a better understanding about how to assemble this kind of bed frame. The bed frame can be folded through the connection with the supporting robs but it links the U shaped metal plate connection to insure the stability and safety of the bed frame. Compared with bed slats or bars which are soldered to be a complete bed frame, with the help of mortise and tenon techniques, this bed frame is decreased one-third of the packaging volume, which means a smaller packaging size to transport. Tailor-made nuts and bolts can be assembled only by an allen wrench. Elliptic pillar nuts are able to perfectly match elliptic holds, which brings fewer slips and more convenience to assemble. Bolts will not be loosened after locking with spring lock washers and metal washers. Adopting plastic fasteners to connect bed slats and the main body of bed frame is easy to assemble and disassemble and reduces the work of locking bolts. Compared with the other structure of completely fixed by bolts, this kind of bed frame reduces 50 percent of the installation workload. The bed is more stable by using supporting rods. Supports and supporting robs strengthen carrying capacity of the bed, which is safer and more comfortable. Adopting supports brings stably support to the whole bed, especially using double supports for the double bed. Therefore, safety of using and comfort can be insured.

### BRIEF INTRODUCTION OF THE DRAWINGS

FIG. 1 is a double bed frame's stereoscopic schematic drawing with the present invention which is an easy assembly metal bed frame.

FIG. 2 is a single bed frame's stereoscopic schematic drawing with the present invention which is an easy assembly metal bed frame.

FIG. 3 is a schematic drawing about the connection between the second main slats and bolts of the present invention which is an easy assembly metal bed frame.

FIG. 4 is an exploded view about the second main slats of the present invention which is an easy assembly metal bed frame.

FIG. 5 is an installation drawing about the U shaped metal plate connection of the present invention which is an easy assembly metal bed frame.

FIG. 6 is a decomposition drawing about how to install the elliptic pillar nuts which is from the present invention that is an easy assembly metal bed frame.

FIG. 7 is a plan view about a double bed with the present invention which is an easy assembly metal bed frame.

FIG. 8 is a plan view about a single bed with the present invention which is an easy assembly metal bed frame.

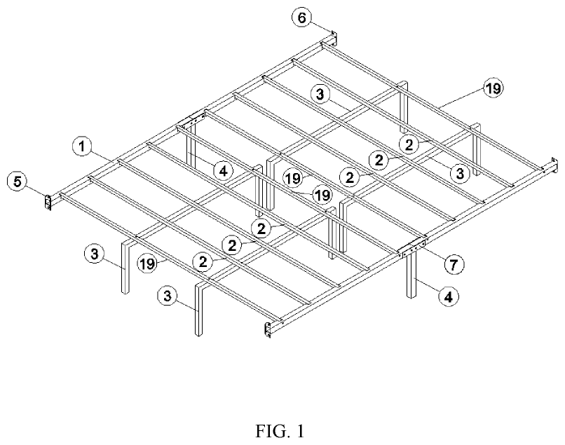

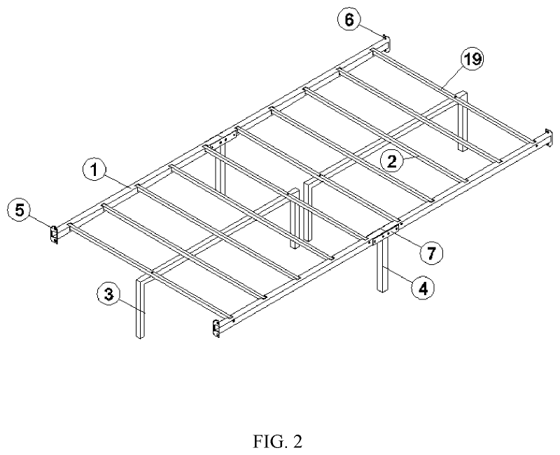

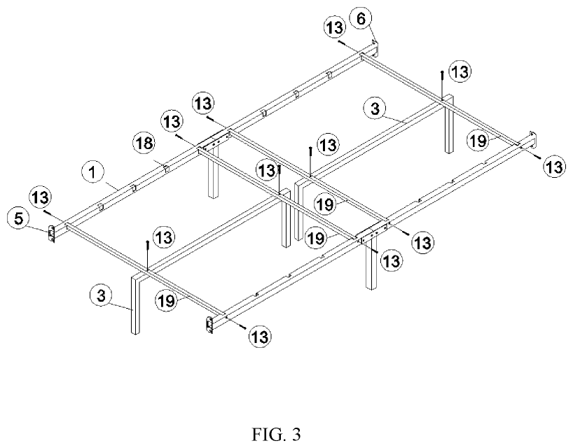

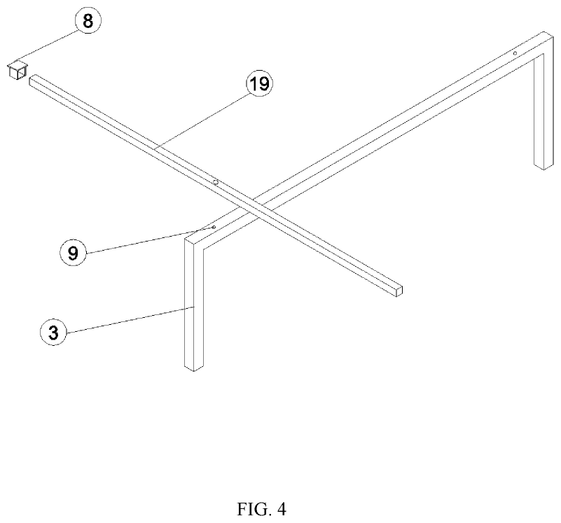

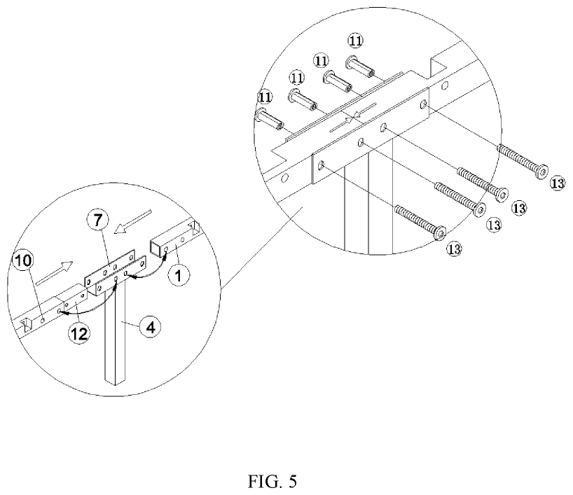

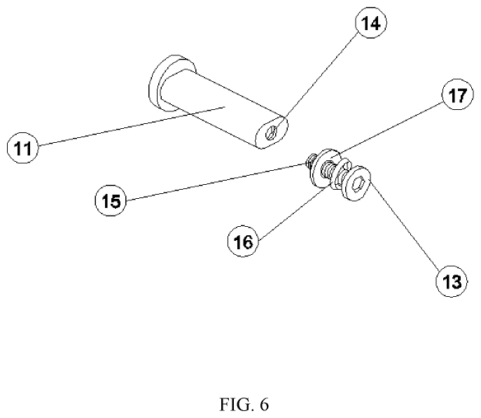

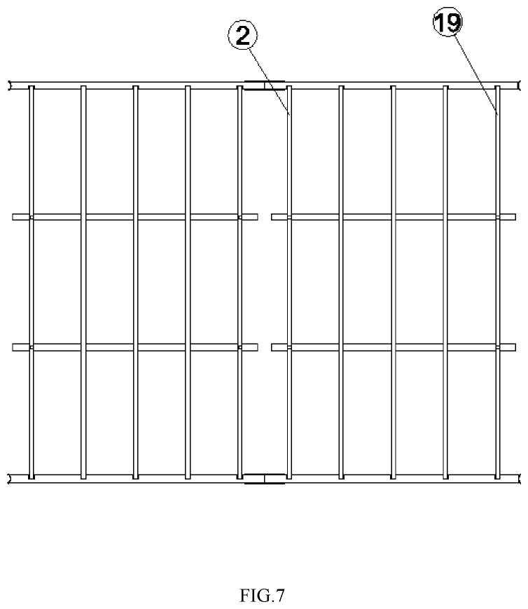

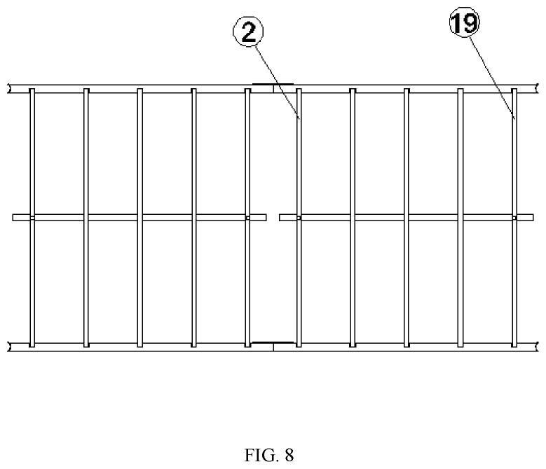

FIG. 1-8: 1.bed frame; 2.the first main slat; 3.support; 4.supporting robs; 5.metal plate connection; 6.elliptic hole; 7.U shaped metal plate connection; 8.plastic fastener; 9.fixed hole; 10.elliptic through hole; 11. elliptic pillar nut; 12.mortise block; 13 bolt; 14.threaded hole; 15.threaded rod; 16.spring lock washer; 17.metal washer; 18.fixed slot; 19.the second main slat.

### DETAILED DESCRIPTION OF THE PREFERRED EMBODIMENTS

The disclosure may be more completely understood in consideration of the following detailed description of various embodiments of the disclosure in connection with accompanying drawings. Since many embodiments of the invention can be made without departing from the spirit and scope of the invention, the invention resides in the claims hereinafter appended.

Referring to FIGS. 1 to 8, an embodiment of the easy assembly metal bed frame according to the present invention is shown. A metal bed frame which is easy assembly, comprising a bed frame 1, the first main slats 2, supports 3 and supporting rods 4, characterized in that: two ends of the bed frame 1 are welded metal plate connections 5, and the structure of the bed frame 1 is a hollow tubular structure. Metal plate connections 5 are provided with elliptical holes 6, and said the elliptical holes 6 are symmetrically distributed at the both ends of the metal plate connections 5. The bed frame 1 is provided with two bars which are set fixed slot 18 at the inner side of the bed frame 1. One side of the bed frame 1 is movably connected with the first main slats 2 and is fixedly connected with the second main slat 19. And the top surfaces of the second main slats 19 are provided with fixed slots 9. Said the first main slats 2 and the second main slats 19, which are provided with a number of them, are the hollow tubular structure. Said the bottom sides of the second main slats 19 are connected to the supports 3 by screws. For the single bed frame, two supports 3 are provided symmetrically. And for the double bed frame, there are four supports 3 which link to the second main slats 19 vertically by using screws. In the middle of the bed frame 1, the bars are insetted elliptic pillar nuts 11 on one side and bolts 13 on the other side, and both elliptic nuts 11 which provide inner hexagonal slots in order to assemble easily and bolts 13 are threaded connection. The bed frame 1 is linked to supporting rods 4 at the bottom.

Said supporting rods 4 are set U shaped metal plate connections 7 at the top surfaces, and said U shaped metal plate connections 7 are provided several elliptic holes at the both ends. The bed frame can be folded through the connection with the supporting robs 4 but it links the U shaped metal plate connection 7 to insure the stability and safety of the bed frame.

Said bed frame 1 is connected by mortise and tenon techniques. One side of the bed frame 1 fixes with the mortise block 12 which insets the other side of the bed frame 1 and is provided with elliptic slots. There are elliptic holes which share the same side with the elliptic holes on the side face of the bed frame 1. The bed frame 1 is connected to the mortise block 12 by techniques of mortise and tenon. The bed frame is decreased one-third of the packaging volume, which means a smaller packaging size to transport.

Said elliptic pillar nuts 11 have the threaded holes 14 on the other side and the bolts 13 is connected to threaded rods 15 which inlay the spring lock washers 16 that have the metal washers 17 on one side's sliding joint. Said threaded rods 15 and the threaded holes 14 make a threaded connection. Tailor-made nuts and bolts can be assembled only by an allen wrench. Elliptic pillar nuts 11 are able to perfectly match elliptic holes 10, which brings fewer slips and more convenience to assemble. Bolts will not be loosened after locking with spring lock washers 16 and metal washers 17.

Said the first main slats 2 and the second main slats 9 are insetted plastic fasteners 8 which are connected to fixed slots 18 by the mortise and tenon techniques, and the outside size of plastic fasteners 8 and the fixed slots 18 share the same size. Adopting plastic fasteners 8 to connect the first main slats 2/the second main slats 19 and the main body of bed frame is easy to assemble and disassemble and reduces the work of locking bolts. Compared with the other structure of completely fixed by bolts, this kind of bed frame reduces 50 per cent of the installation workload.

Said each supports 3 are equipped with rivet nuts and are fixed with the second main slats 19 by using bolts holding the first main slats 2. Supports 3 strengthens carrying capacity of the bed through holding the first main slats 2 and the second man slats 19, which is safer and more comfortable. Adopting supports 3 brings stably support to the whole bed, especially using double supports for the double bed. Therefore, safety of using and comfort can be insured.

Working theory: after unboxing from the package, users can inset the bed frame 1 into the mortise blocks 12 in order to connect two parts of the bed frame 1. The bed frame can be folded through the connection with the supporting robs 4 but it links the U shaped metal plate connection 7 to insure the stability and safety of the bed frame. And then, elliptic pillar nuts 11 should be inserted into elliptic holes 10. The bed frame is decreased one-third of the packaging volume, which means a smaller packaging size to transport. Elliptic pillar nuts 11 are able to perfectly match elliptic holes 10, which brings fewer slips and more convenience to assemble. Bolts will not be loosened after locking with spring lock washers 16 and metal washers 17. Tailor-made nuts and bolts can be assembled only by an allen wrench. Adopting plastic fasteners 8 to connect the first main slats 2/ the second main slats 19 and the main body of bed frame is easy to assemble and disassemble and reduces the work of locking bolts. Compared with the other structure of completely fixed by bolts, this kind of bed frame reduces 50 per cent of the installation workload. Users connect the first main slats 2 and the second main slats 19 to the fixed slots. The second main slats 19 should be placed 19 under the supports 3 and fixed by the bolts 13. Supports 3 strengthens carrying capacity of the bed through holding the first main slats 2 and the second man slats 19, which is safer and more comfortable. Adopting supports 3 brings stably support to the whole bed, especially using double supports for the double bed. Therefore, safety of using and comfort can be insured.

Embodiments of the present disclosure may take on various modifications and alterations without departing from the spirit and scope of the disclosure. Accordingly, it is to be understood that the embodiments of the present disclosure are not to be limited to the following described exemplary embodiments, but is to be controlled by the limitations set forth in the claims and any equivalents thereof While the specification has described in the detail certain exemplary embodiments, it will be appreciated that those skilled in the art, upon attaining an understanding of the foregoing, may readily conceive of alternations to, variations of, and equivalents to these embodiments.

We claim:

1, A metal bed frame which is easy assembly, comprising a bed frame 1, the first main slats 2, supports 3 and supporting rods 4;
wherein two ends of the bed frame 1 are welded metal plate connections 5, and the structure of the bed frame 1 is a hollow tubular structure;
wherein metal plate connections 5 are provided with elliptical holes 6, and said the elliptical holes 6 are symmetrically distributed at the both ends of the metal plate connections 5;
wherein the bed frame 1 is provided with two bars which are set fixed slot 18 at the inner side of the bed frame 1;
wherein one side of the bed frame 1 is movably connected with the first main slats 2 and is fixedly connected with the second main slat 19;
wherein the top surfaces of the second main slats 19 are provided with fixed slots 9;
wherein said the first main slats 2 and the second main slats 19, which are provided with a number of them, are the hollow tubular structure;
wherein said the bottom sides of the second main slats 19 are connected to the supports 3 by screws;
wherein for the single bed frame, two supports 3 are provided symmetrically, and for the double bed frame, there are four supports 3 which link to the second main slats 19 vertically by using screws;
wherein in the middle of the bed frame 1, the bars are insetted elliptic pillar nuts 11 on one side and bolts 13 on the other side, and both elliptic nuts 11 which provide inner hexagonal slots in order to assemble easily and bolts 13 are threaded connection;
wherein the bed frame 1 is linked to supporting rods 4 at the bottom;

2, The metal easy assembly bed frame in accordance with claim 1, characterized in that, said supporting rods 4 are set U shaped metal plate connections 7 at the top surfaces, and wherein said U shaped metal plate connections 7 are provided several elliptic holes at the both ends.

3, The metal easy assembly bed frame in accordance with claim 1, characterized in that, said bed frame 1 is connected by mortise and tenon techniques, and one side of the bed frame 1 fixes with the mortise block 12 which insets the other side of the bed frame 1 and is provided with elliptic slots; wherein there are elliptic through holes 10 which share the same side with the elliptic slots on the side face of the bed frame 1.

4, The metal easy assembly bed frame in accordance with claim 1, characterized in that, said elliptic pillar nuts 11 have the threaded holes 14 on the other side and the bolts 13 is connected to threaded rods 15 which inlay the spring lock washers 16 that have the metal washers 17 on one side's sliding joint; wherein said threaded rods 15 and the threaded holes 14 make a threaded connection.

5, The metal easy assembly bed frame in accordance with claim 1, characterized in that, said the first main slats 2 and the second main slats 9 are insetted plastic fasteners 8 which are connected to fixed slots 18 by the mortise and tenon techniques, and the outside size of plastic fasteners 8 and the fixed slots 18 share the same size.

6, The metal easy assembly bed frame in accordance with claim 1, characterized in that, said each supports 3 are equipped with rivet nuts and are fixed with the second main slats 19 by using bolts holding the first main slats 2.
